(19) United States
(12) Patent Application Publication
(10) Pub. No.: US 2014/0330954 A1
(43) Pub. Date: Nov. 6, 2014

(54) METHOD AND APPARATUS FOR PROCESSING INFORMATION BASED ON SOCIAL PLATFORM

(71) Applicant: TENCENT TECHNOLOGY (SHENZHEN) COMPANY LIMITED, Shenzhen (CN)

(72) Inventor: Huayong WANG, Shenzhen (CN)

(21) Appl. No.: 14/335,562

(22) Filed: Jul. 18, 2014

Related U.S. Application Data
(63) Continuation of application No. PCT/CN2014/072938, filed on Mar. 5, 2014.

(30) Foreign Application Priority Data
Apr. 9, 2013 (CN) 201310121558.0

(51) Int. Cl. H04L 12/24

(52) U.S. Cl. CPC H04L 41/00
USPC 709/223

(57) ABSTRACT

Method and device for processing information based on a social platform are disclosed. The method for processing information based on a social platform, comprising: acquiring, by a server, a request for characteristic data from a requester, wherein the request comprises identification information of the requester and/or identification information of a requested user; calculating, by the server, the characteristic data under a particular scenario in response to the request; transmitting, by the server, the calculated characteristic data to the requester or the requester. Through the methods and devices as disclosed, different social platform users may be able to communicate with each other in different virtual scenarios.

### CROSS REFERENCE TO RELATED APPLICATIONS

This is a continuation application of International Patent Application No.: PCT/CN2014/072938, filed on Mar. 5, 2014, which claims priority to Chinese Patent Application CN201310121558.0, filed on Apr. 9, 2013, the disclosures of which are incorporated by reference herein in their entirety.

### TECHNICAL FIELD

The present disclosure relates to the field of internet communications, and in particular to a method and an apparatus for processing information based on a social platform.

### BACKGROUND

With the development of internet technologies, social networks become even more popular. Various new established social platforms enhance the contacts and information interactions between different users. To increase the flexibility of information interactions between different users, there is a need to provide a new method for processing information based on a social platform and the apparatus thereof.

### SUMMARY

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

The present disclosure provides a method for processing information based on a social platform, comprising the following steps: the server acquires a request for characteristic data from a requester, wherein the request comprises identification information of the requester and/or identification information of a requested user; the server calculates the characteristic data under a particular scenario in response to the request; and the server transmits the calculated characteristic data to the requester or the requester.

In one example, when the request comprises the identification information of the requester, the calculating step may comprise: calculating, by the server, the characteristic data of the requester under the particular scenario based on the identification information of the requester.

In another example, when the request comprises the identification information of the requester and the identification information of the requested user, the calculating step may comprise: calculating, by the server, the characteristic data of the requested user under the particular scenario based on the identification information of the requester and the identification information of the requested user.

In yet another example, when the request comprises the identification information of the requester, the calculating step may comprise: calculating, by the server, the characteristic data of a predetermined number of randomly selected users under the particular scenario based on the identification information of the requester and the identification information of the predetermined number of randomly selected users.

The present disclosure provides another method for processing information based on a social platform, comprising the following steps: the server acquires identification information of a designated user and/or identification information of a predetermined number of randomly selected users; the server calculates the characteristic data under a particular scenario based on the identification information of the designated user and/or the identification information of the predetermined number of randomly selected users; and the server transmits the calculated characteristic data to the designated user.

In one example, when the identification information of the designated user is acquired, the calculating step may comprise: the server calculates the characteristic data of the designated user under the particular scenario based on the identification information of the designated user.

In another example, when the identification information of the designated user and the identification information of the predetermined number of randomly selected users are acquired, the calculating step may comprise: calculating, by the server, the characteristic data of the predetermined number of randomly selected users under the particular scenario based on the identification information of the designated user.

The present disclosure also provides An apparatus for processing information based on a social platform, comprising: an acquisition module, configured to acquire a request for characteristic data from a requester, wherein the request comprises identification information of the requester and/or identification information of a requested user; a calculation module, configured to calculate the characteristic data under a particular scenario in response to the request; a transmission module, configured to transmit the calculated characteristic data to the requester or the requester.

In one example, the calculation module is further configured to, when the request comprises the identification information of the requester, calculate the characteristic data of the requester under the particular scenario based on the identification information of the requester.

In another example, the calculation module may further be configured to, when the request comprises the identification information of the requester and the identification information of the requested user, calculate the characteristic data of the requested user under the particular scenario based on the identification information of the requester and the identification information of the requested user.

In yet another example, the calculation module may further be configured to, when the request comprises the identification information of the requester, calculate the characteristic data of a predetermined number of randomly selected users under the particular scenario based on the identification information of the requester and the identification information of the predetermined number of randomly selected users.

The present disclosure further provides an apparatus processing information based on a social platform, comprises: an acquisition module, configured to acquire identification information of a designated user and/or identification information of a predetermined number of randomly selected users; a calculation module, configured to calculate the characteristic data under a particular scenario based on the identification information of the designated user and/or the identification information of the predetermined number of randomly selected users; and a transmission module, configured to transmit the calculated characteristic data to the designated user

In one example, the calculation module is further configured to, when the identification information of the designated user is acquired, calculate the characteristic data of the designated user under the particular scenario based on the identification information of the designated user.

In another example, the calculation module is further configured to, when the identification information of the designated user and the identification information of the predetermined number of randomly selected users are acquired, calculate the characteristic data of the predetermined number of randomly selected users under the particular scenario based on the identification information of the designated user.

The identification information as provided above may comprise at least one of: a user identification ID, a user nickname, a user portrait and a user label.

Further, the server of the present disclosure may be provided with a storage module or a upgrading module, wherein the storage module may be configured to store the calculated characteristic data locally, and the upgrading module may be configured to upgrade the value of the characteristic data under the particular scenario according to a keyword of the User label.

Through the methods and devices provided above, it will be very convenient for a social platform user to take part in a virtual scenario or invite another social platform user to take part in a virtual scenario, and different social platform users may be able to communicate with each other in different virtual scenarios. In this way, there is provided a new way for communications between social platform users, which should be more attractive compared with communications between social platform users according to the prior art.

### BRIEF DESCRIPTION OF THE DRAWINGS

FIG. 1 illustrates a particular scenario (for example, a restaurant) provided by a social platform, in which there are many virtual roles;

FIG. 2 illustrates a first embodiment according to the present disclosure;

FIG. 3 illustrates a second embodiment according to the present disclosure;

FIG. 4 illustrates a third embodiment according to the present disclosure;

FIG. 5 illustrates a fourth embodiment according to the present disclosure;

FIG. 6 illustrates a fifth embodiment according to the present disclosure;

FIG. 7 illustrates a structure for implementing methods and devices according to the present disclosure.

FIG. 8 depicts an exemplary environment incorporating certain disclosed embodiments; and

FIG. 9 depicts an exemplary computing system consistent with the disclosed embodiments.

### DETAILED DESCRIPTION

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Nowadays, social platforms, for example, blogs are becoming more and more popular, and there are many social platform users in a social platform. Usually, a social platform user may communicate with another social platform user by sending messages. In order to increase interestingness of communicating with other social platform users, there is a need to provide a new method for social platform users to communicate with each other.

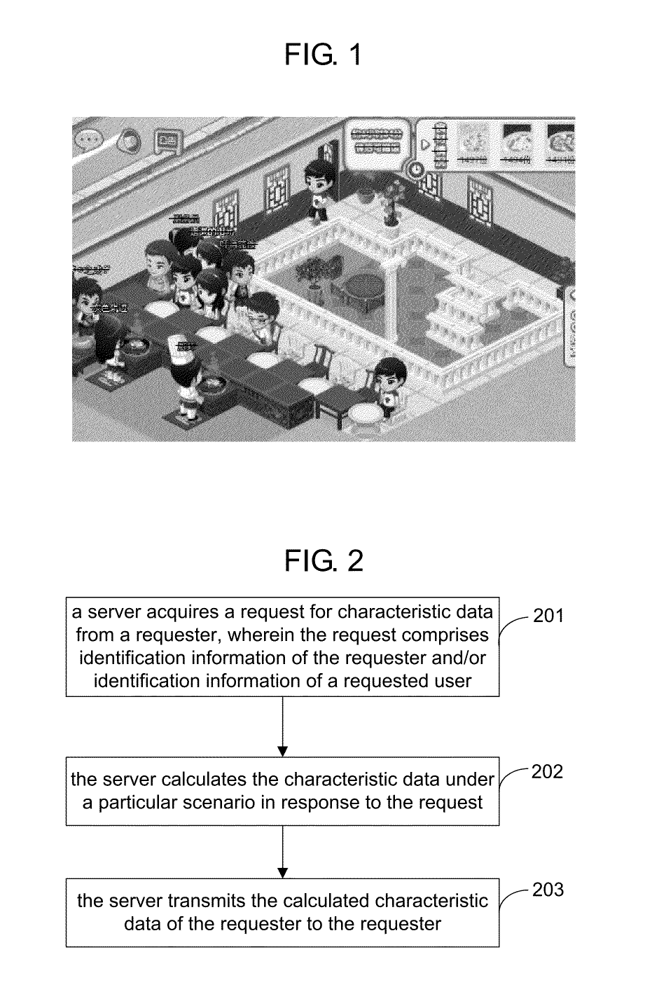

FIG. 1 illustrates a particular scenario (for example, a restaurant) provided by a social platform, in which there are many virtual roles. Each role in this scenario is defined by several characteristics, for example, virtual career, power, intelligence and so on. A role in this particular scenario may wish to invite his/her friend users to take part in this particular scenario, and a new role will also be assigned with respective characteristics, for example, virtual career, power, intelligence and so on.

The present disclosure provides methods and devices for determining characteristic data for a virtual role.

FIG. 2 illustrates a first embodiment of the present disclosure. According to the first embodiment of the present disclosure, a server may acquire a request for characteristic data from a requester, wherein the request comprises identification information of the requester and/or identification information of a requested user (Step 201).

Identification information of a social platform user refers to information for identifying said social platform user, such as a user identification ID, a user nickname, a user portrait and a user label and so on. The user label is composed of certain keywords for describing said social platform user, such as “engineer,” “professor” or “intelligence.” The present disclosure does not intend to limit the types of the characteristic data, and any type of characteristic data should be within the scope of the present disclosure.

The server calculates the characteristic data under a particular scenario in response to the request (Step 202).

The particular scenario refers to activity scenarios of the social platform, as shown in FIG. 1 of the present disclosure. The characteristic data under the particular scenario refers to characteristic data configured to enable the social platform user to communicate with other users under the particular scenario.

The entities for implementing the information processing method according to the present disclosure may be a specific server. In an example, the entities for implementing the information processing method may store the characteristic data locally.

Additionally, in the first embodiment of the present disclosure, a requester transmits a request to a server, for acquiring the characteristic data of the requester under a particular scenario. The request comprises identification information of the requester. The server extracts the identification information of the requester from the request.

In this embodiment, the server calculates the characteristic data of the requester according to the identification information of the requester. Then, the server transmits the calculated characteristic data of the requester to the requester (Step 203). In an example, the calculated characteristic data may also be stored in the server locally. In practice, there are many ways for calculating the characteristic data, and the present disclosure does not intended to be limited to any particular way for calculating the characteristic data.

As an example, the following provides a method for calculating characteristic data of a user under a particular scenario according to a user ID:

Step a: converting letters, characters, and numerals of the user ID into key values, and subtracting 48 from each of the key values, so as to form a string of numerals;

Step b: dividing the string of numerals by 7, and reserving the most previous 10 numerals of the quotient. If the quotient is less than ten numerals, then zeros will be padded at the end of the quotient, so that the quotient will have ten numerals.

Step c: based on the result of Step b, the characteristic data of the user will be obtained according to a predetermined calculation rule.

For example, if the user ID is “adesso”, the key values corresponding to the user ID “adesso” will be 65, 68, 69, 83, 83 and 79, respectively. A string of numerals 172021353531 will be obtained by subtracting 48 from the respective key values. Then, the string of numerals 172021353531 is divided by 7, and the most previous 10 numerals of the quotient are reserved, the result will be 2457447907

The characteristic data of the user under the particular scenario is calculated as follows:

The characteristic data A=(the first numeral from the left of the result×10)+the second numeral from the left of the result;

The characteristic data B=(the third numeral from the left of the result×10)+the fourth numeral from the left of the result;

The characteristic data C=(the fifth numeral from the left of the result×10)+the sixth numeral from the left of the result;

The characteristic data D=(the seventh numeral from the left of the result×10) +the eighth numeral from the left of the result.

According to the above rule, when the result of step b is 2457447907, then the characteristic data A, B, C and D will be 24, 57, 44 and 79, respectively.

According to an example of the present disclosure, when the characteristic data of the user is determined based on a user label, the value of the characteristic data may be upgraded according to a keyword of the user label. For example, if the user label comprises a keyword “engineer,” then the value of the characteristic data A (for example, intelligence) will be upgraded. For another example, if the user label comprises a keyword “athlete,” then the value of the characteristic data B (for example, power) will be upgraded.

After a user has been assigned with characteristics, the user may then be able to take part in this scenario provide by the social platform. Social platform users may be able to communicate with each other in this particular scenario (for example, virtual restaurant). In this way, the present disclosure provides another way for social platform users to communicate with each other, which also improves the flexibility of communications between social platform users.

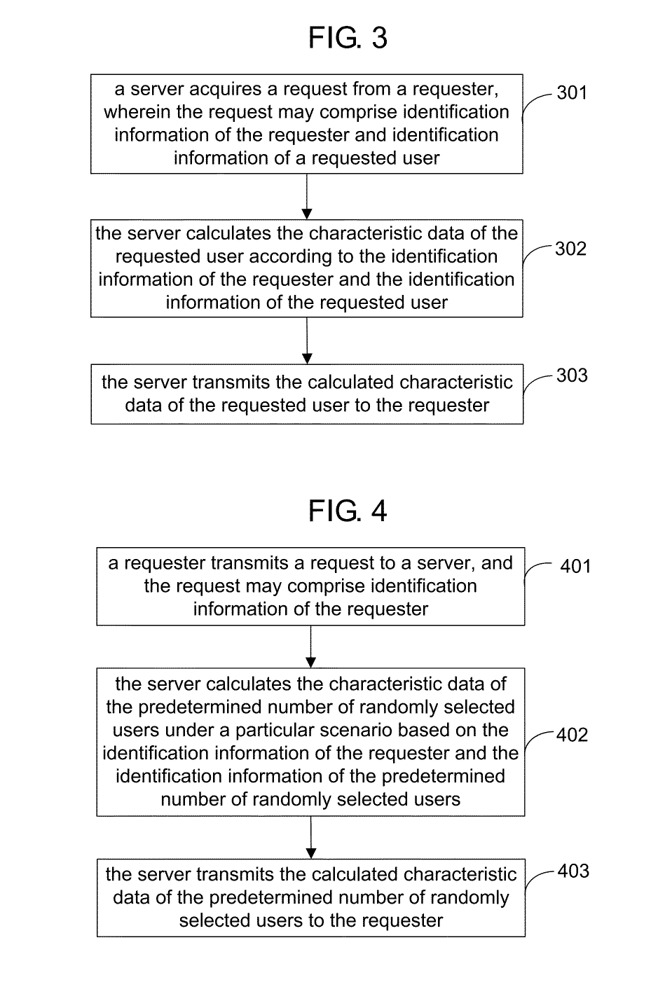

FIG. 3 illustrates a second embodiment of the present disclosure. According to the second embodiment of the present disclosure, a server acquires a request from a requester, wherein the request may comprise identification information of the requester and identification information of a requested user (Step 301). The requester refers to a user that requests for characteristic data, while the requested user refers to a user being requested by the requester. The server extracts the identification information of the requester and the identification information of the requested user from the request.

In this embodiment, the server calculates the characteristic data of the requested user according to the identification information of the requester and the identification information of the requested user (Step 302). Then, the server transmits the calculated characteristic data of the requested user to the requester (Step 303). In an example, the calculated characteristic data of the requested user may also be stored in the server locally. In practice, there are many ways for calculating the characteristic data, and the present disclosure does not intended to be limited to any particular way for calculating the characteristic data.

As an example, the following provides a method for calculating characteristic data of a requested user under a particular scenario according to a user ID:

Step a: converting letters, characters, and numerals in the user ID of the requester into key values, and subtracting 48 from each of the key values, so as to form a string of numerals; converting letters, characters, and numerals in the user ID of the requested user into key values, and subtracting 48 from each of the key values, so as to form another string of numerals.

Step b: for each of the above two strings of numerals, dividing the string of numerals by 7, and reserving the most previous 10 numerals of the quotient. If the quotient is less than ten numerals, then zeros will be padded at the end of the quotient, so that the quotient will have ten numerals. Then, since there are two strings of numerals, two results will be obtained.

Step c: the two results will be added. Based on the addition of the two results, the characteristic data of the requested user will be obtained according to a predetermined calculation rule. The predetermined calculation rule employed in the second embodiment may be the same as that employed in the first embodiment, although a different calculation rule may also be employed.

Additionally, the particular scenario according to the second embodiment may be the particular scenario of the requester. That is, the requester may request other users to take part in the particular scenario of the requester. Based on the characteristic data of the requested user under the particular scenario of the requester, there is provided another flexible way for the requester to communicate with the requested user.

To facilitate understanding of the present disclosure, here is provided an example. If a social platform user A is now playing an online game on his terminal, and a particular scenario is shown on his terminal. The social platform user A sends a request to a server for requesting a social platform user B to take part in the particular scenario on his terminal. The request comprises identification information of the social platform user A and the identification information of the social platform user B.

Based on the identification information of the social platform user A and the identification information of the social platform user B, the server may determine the characteristic data of the social platform user B under the particular scenario, for example, power, intelligence and so on. In this way, the social platform user B then may take part in the online game of the social platform user A.

FIG. 4 illustrates a third embodiment of the present disclosure. According to the third embodiment of the present disclosure, a requester may transmit a request to a server, and the request may comprise identification information of the requester (Step 401). The server may voluntarily select a predetermined number of randomly selected users in response to the request. Then, the server calculates the characteristic data of the predetermined number of randomly selected users under a particular scenario based on the identification information of the requester and the identification information of the predetermined number of randomly selected users (Step 402). The server may transmit the calculated characteristic data of the predetermined number of randomly selected users to the requester (Step 403). In an example, the predetermined number of randomly selected users may be friend users of the requester.

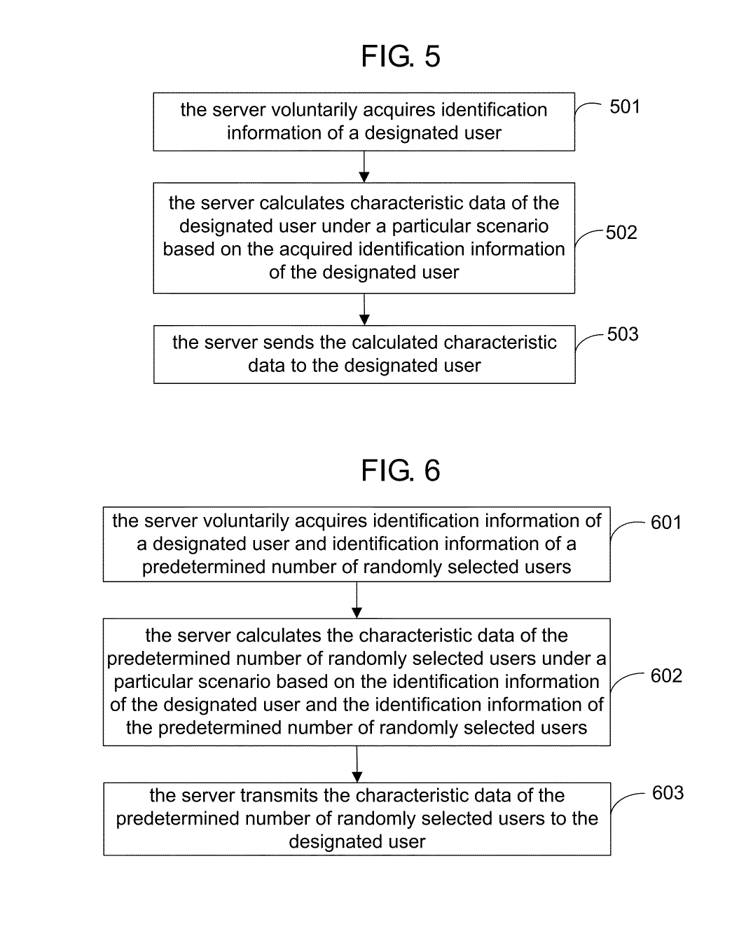

FIG. 5 illustrates a fourth embodiment of the present disclosure. According to the fourth embodiment of the present disclosure, the server may voluntarily acquire identification information of a designated user (Step 501). That is, the server is capable of calculating characteristic data of the designated user under a particular scenario based on the acquired identification information of the designated user (Step 502), and sending the calculated characteristic data to the designated user (Step 503). In this way, the server may be able to voluntarily invite a social platform user to take part in an online game. Here, the social platform user being invited is referred to as the designated user.

In this embodiment, the calculated characteristic data may also be stored in the server locally. Any suitable algorithm may be employed to determine the characteristic data of the designated user.

FIG. 6 illustrates a fifth embodiment of the present disclosure. According to the fifth embodiment of the present disclosure, the server may voluntarily acquire identification information of a designated user and identification information of a predetermined number of randomly selected users (Step 601). That is, the server is capable of calculating the characteristic data of the predetermined number of randomly selected users under a particular scenario based on the identification information of the designated user and the identification information of the predetermined number of randomly selected users (Step 602), and transmitting the characteristic data of the predetermined number of randomly selected users to the designated user (Step 603).

In this embodiment, the calculated characteristic data may also be stored in the server locally. Any suitable algorithm may be employed to determine the characteristic data of the designated user.

It should be pointed out, when characteristic data of a user is determined based on the user's nickname, the nickname should first be converted to letters and/or characters, and the calculation of the characteristic data is being performed based on these letters and/or characters

When characteristic data of a user is determined based on the user's portrait, part or all of the user's portrait should converted to a serial of chromaticity values, and the calculation of the characteristic data is being performed based on these chromaticity values. Specially, a user's portrait may be divided into 10 blocks, and chromaticity values of each of these 10 blocks are converted into corresponding key values; then, key values of each of these 10 blocks are added together to form a numeral. Therefore, for each block, there will be a corresponding numeral, i.e. 10 numerals will be obtained. Further, 10 numerals will form a result having 10 numerals.

For example, chromaticity values for a block are #ccf56b, #cc0099, #563457, and these chromaticity values are converted to be key values 31919225618, 319190099, 3563457, respectively, and these key values are further added together to form a numeral 4, thus this block has a corresponding number 4. The same operations will be performed on each of 10 blocks, so as to obtain 10 numerals. These 10 numerals will form a result having 10 numerals.

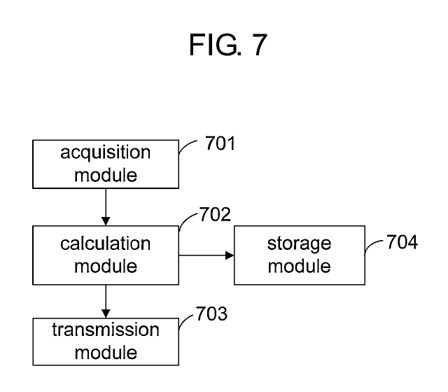

The present disclosure also provides an apparatus for processing information based on a social platform, as shown in FIG. 7 of the present disclosure. The system comprises: an acquisition module 701, a calculation module 702 and a transmission module 703.

In an example, the acquisition module 701 is configured to acquire a request for characteristic data from a requester, wherein the request comprises identification information of the requester and/or identification information of a requested user.

The calculation module 702 is configured to calculate the characteristic data under a particular scenario in response to the request.

Further, the transmission module 703 is configured to transmit the calculated characteristic data to the requester or the requester.

Optionally, the apparatus may also comprise a storage module 704, configured to store the calculated characteristic data.

In another example, the acquisition module 701 may be configured to acquire identification information of a designated user and/or identification information of a predetermined number of randomly selected users.

Further, the calculation module 702 may be configured to calculate the characteristic data under a particular scenario based on the identification information of the designated user and/or the identification information of the predetermined number of randomly selected users.

The transmission module 703 may be configured to transmit the calculated characteristic data to the designated user.

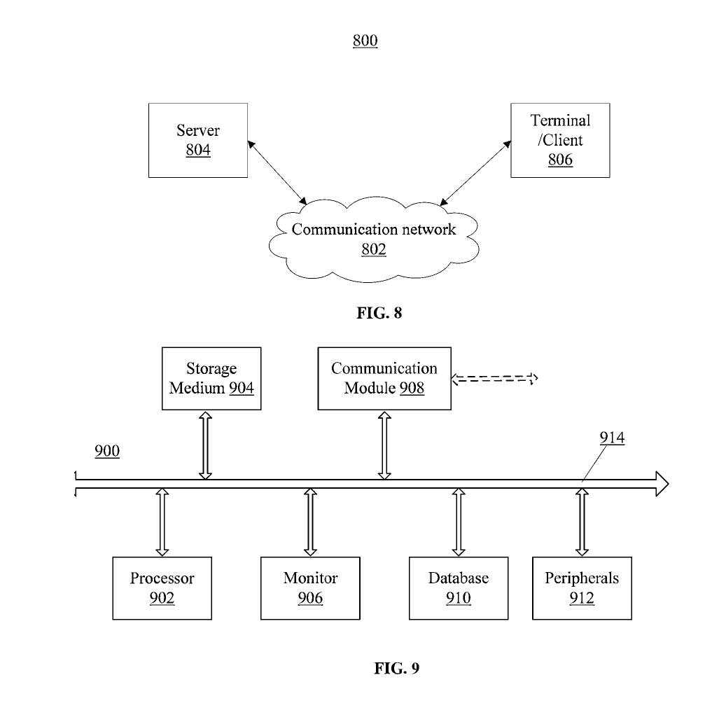

FIG. 8 illustrates an exemplary environment 800 incorporating exemplary methods and systems for processing information based on a social platform in accordance with various disclosed embodiments. As shown in FIG. 8, the environment 800 can include a server 804, a terminal 806, and a communication network 802. The server 804 and the terminal 806 may be coupled through the communication network 802 for information exchange including, e.g., sending/receiving a request for characteristic data, calculated characteristic data, etc. Although only one terminal 806 and one server 804 are shown in the environment 800, any number of terminals 806 or servers 804 may be included, and other devices may also be included.

The communication network 802 may include any appropriate type of communication network for providing network connections to the server 804 and terminal 806 or among multiple servers 804 or terminals 806. For example, the communication network 802 may include the Internet or other types of computer networks or telecommunication networks, either wired or wireless.

A terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other client-side computing device.

A server, as used herein, may refer to one or more server computers configured to provide certain server functionalities, e.g., receiving a request for characteristic data, calculating the characteristic data under a particular scenario data, and sending the calculated characteristic data and etc. A server may also include one or more processors to execute computer programs in parallel.

The server 804 and the terminal 806 may be implemented on any appropriate computing platform.

FIG. 9 shows a block diagram of an exemplary computing system 900 (or computer system 900) capable of implementing the server 804 and/or the terminal 806. As shown in FIG. 9, the exemplary computer system 900 may include a processor 902, a storage medium 904, a monitor 906, a communication module 908, a database 910, peripherals 912, and one or more bus 914 to couple the devices together. Certain devices may be omitted and other devices may be included.

The processor 902 can include any appropriate processor or processors. Further, the processor 902 can include multiple cores for multi-thread or parallel processing. The storage medium 904 may include memory modules, e.g., Read-Only Memory (ROM), Random Access Memory (RAM), and flash memory modules, and mass storages, e.g., CD-ROM, U-disk, removable hard disk, etc. The storage medium 904 may store computer programs for implementing various processes (e.g., receiving a request for characteristic data, calculating the characteristic data under a particular scenario data, and sending the calculated characteristic data and etc), when executed by the processor 902.

The monitor 906 may include display devices for displaying contents in the computing system 900, e.g., displaying a request for characteristic data and the calculated characteristic data and etc. The peripherals 912 may include I/O devices such as keyboard and mouse.

Further, the communication module 908 may include network devices for establishing connections through the communication network 802. The database 910 may include one or more databases for storing certain data and for performing certain operations on the stored data, e.g., storing the calculated characteristic data and etc.

In operation, the terminal 806 may cause the server 804 to perform certain actions, e.g., receiving a request for characteristic data, calculating the characteristic data under a particular scenario data, and sending the calculated characteristic data and etc. The server 804 may be configured to provide structures and functions for such actions and operations.

In various embodiments, a terminal involved in the disclosed methods and systems can include the terminal 806, while a server involved in the disclosed methods and systems can include the server 804. The methods and systems disclosed in accordance with various embodiments can be executed by a computer system. In one embodiment, the disclosed methods and systems can be implemented by a server.

Various embodiments provide methods and systems for processing information based on a social platform. The methods and systems are illustrated in various examples described herein.

Through the methods and devices provided above, it will be very convenient for a social platform user to take part in a virtual scenario or invite another social platform user to take part in a virtual scenario, and different social platform users may be able to communicate with each other in different virtual scenarios. In this way, there is provided a new way for communications between social platform users, which should be more attractive compared with communications between social platform users according to the prior art.

Those ordinarily skilled in the art would appreciate that the above steps or modules may be implemented by one or more processors with computer program running thereon. The computer program can be stored in a non-transitory computer-readable storage medium. When the computer program is executed, the above steps or units can be included. The storage medium can be a disk, a compact disk, a Read-Only Memory (ROM), a Random Access Memory (RAM) or the like.

Obviously, those skilled in the art can make various modifications and variations to the disclosure without departing from the spirit and scope of the disclosure. Thus, if these modifications and variations of the disclosure fall within the scope of the claims of the disclosure and equivalent technologies thereof, the disclosure is also intended to include these modifications and variations.

1. A method for processing information based on a social platform, comprising:
acquiring, by a server, a request for characteristic data from a requester, wherein the request comprises identification information of the requester and/or identification information of a requested user;
calculating, by the server, the characteristic data under a particular scenario in response to the request;
transmitting, by the server, the calculated characteristic data to the requester.

2. The method according to claim 1, wherein the request comprises the identification information of the requester, the calculating step comprises:
calculating, by the server, the characteristic data of the requester under the particular scenario based on the identification information of the requester.

3. The method according to claim 1, wherein the request comprises the identification information of the requester and the identification information of the requested user, the calculating step comprises:
calculating, by the server, the characteristic data of the requested user under the particular scenario based on the identification information of the requester and the identification information of the requested user.

4. The method according to claim 1, wherein the request comprises the identification information of the requester, the calculating step comprises:
calculating, by the server, the characteristic data of a predetermined number of randomly selected users under the particular scenario based on the identification information of the requester and the identification information of the predetermined number of randomly selected users.

5. The method according to claim 1, wherein the identification information comprises at least one of: a user identification ID, a user nickname, a user portrait and a user label.

6. The method according to claim 5 further comprises:
upgrading, by the server, the value of the characteristic data under the particular scenario according to a keyword of the user label.

7. A method for processing information based on a social platform, comprising:
acquiring, by a server, identification information of a designated user and/or identification information of a predetermined number of randomly selected users;
calculating, by the server, the characteristic data under a particular scenario based on the identification information of the designated user and/or the identification information of the predetermined number of randomly selected users; and
transmitting, by the server, the calculated characteristic data to the designated user.

8. The method according to claim 7, wherein the identification information of the designated user is acquired, the calculating step comprises:
calculating, by the server, the characteristic data of the designated user under the particular scenario based on the identification information of the designated user.

9. The method according to claim 7, wherein the identification information of the designated user and the identification information of the predetermined number of randomly selected users are acquired, the calculating step comprises:
calculating, by the server, the characteristic data of the predetermined number of randomly selected users under the particular scenario based on the identification information of the designated user.

10. The method according to claim 7, wherein the identification information comprises at least one of: a user identification ID, a user nickname, a user portrait and a user label.

11. The method according to claim 10 further comprises:
upgrading, by the server, the value of the characteristic data under the particular scenario according to a keyword of the User label.

12. An apparatus for processing information based on a social platform, comprising:
an acquisition module, configured to acquire a request for characteristic data from a requester, wherein the request comprises identification information of the requester and/or identification information of a requested user;
a calculation module, configured to calculate the characteristic data under a particular scenario in response to the request;
a transmission module, configured to transmit the calculated characteristic data to the requester.

13. The apparatus according to claim 12, wherein the calculation module is further configured to, when the request comprises the identification information of the requester, calculate the characteristic data of the requester under the particular scenario based on the identification information of the requester.

14. The apparatus according to claim 12, wherein the calculation module is further configured to, when the request comprises the identification information of the requester and the identification information of the requested user, calculate the characteristic data of the requested user under the particular scenario based on the identification information of the requester and the identification information of the requested user.

15. The apparatus according to claim 12, wherein the calculation module is further configured to, when the request comprises the identification information of the requester, calculate the characteristic data of a predetermined number of randomly selected users under the particular scenario based on the identification information of the requester and the identification information of the predetermined number of randomly selected users.

16. An apparatus for processing information based on a social platform, comprising:
an acquisition module, configured to acquire identification information of a designated user and/or identification information of a predetermined number of randomly selected users;
a calculation module, configured to calculate the characteristic data under a particular scenario based on the identification information of the designated user and/or the identification information of the predetermined number of randomly selected users; and
a transmission module, configured to transmit the calculated characteristic data to the designated user.

17. The apparatus according to claim 16, wherein the calculation module is further configured to, when the identification information of the designated user is acquired, calculate the characteristic data of the designated user under the particular scenario based on the identification information of the designated user.

18. The apparatus according to claim 16, wherein the calculation module is further configured to, when the identification information of the designated user and the identification information of the predetermined number of randomly selected users are acquired, calculate the characteristic data of the predetermined number of randomly selected users under the particular scenario based on the identification information of the designated user.

19. A non-transitory computer readable medium, comprising instructions stored thereon, the instructions being executable by one or more processors for implementing the following:
acquiring a request for characteristic data from a requester, wherein the request comprises identification information of the requester and/or identification information of a requested user;
calculating the characteristic data under a particular scenario in response to the request; and
transmitting the calculated characteristic data to the requester.

20. A non-transitory computer readable medium, comprising instructions stored thereon, the instructions being executable by one or more processors for implementing the following:
acquiring identification information of a designated user and/or identification information of a predetermined number of randomly selected users;
calculating the characteristic data under a particular scenario based on the identification information of the designated user and/or the identification information of the predetermined number of randomly selected users; and
transmitting the calculated characteristic data to the designated user.
